(19) United States
(12) Patent Application Publication
(10) Pub. No.: US 2026/0153187 A1
(43) Pub. Date: Jun. 4, 2026

(54) SUPPORT ASSEMBLY FOR PUMP ARRANGEMENT AND METHOD

(71) Applicant: The Gorman-Rupp Company, Mansfield, OH (US)

(72) Inventors: Thomas Headley, Bryan, OH (US); Canlong He, St. Peters, MO (US)

(21) Appl. No.: 19/406,706

(22) Filed: Dec. 2, 2025

Related U.S. Application Data
(60) Provisional application No. 63/727,439, filed on Dec. 3, 2024.

(51) Int. Cl. F16M 13/02

(52) U.S. Cl. CPC F16M 13/02

(57) ABSTRACT

A support assembly and method are provided for reducing a load on a pump. The support assembly includes an annular base support having a first diameter and a second diameter. A first set of threads are formed within the second diameter. The assembly also includes an annular adjustable support having a first diameter portion and a second diameter portion, a second set of threads formed within the second diameter portion. A threaded pairing connection is formed by adjustably coupling the first set of threads of the annular base support with the second set of threads of the annular adjustable support. A formation is provided that extends from the annular adjustable support for coupling to a pump during use.

### CROSS REFERENCES TO RELATED APPLICATIONS

The following application claims priority under 35 U.S.C. § 119(e) to co-pending U.S. Provisional Patent Application Ser. No. 63/727,439 filed Dec. 3, 2024 entitled SUPPORT ASSEMBLY FOR PUMP ARRANGEMENT AND METHOD. The above-identified application is incorporated herein by reference in its entirety for all purposes.

### TECHNICAL FIELD

The present disclosure generally relates to a support assembly for a pump and method and, more particularly, an assembly and method of supporting a pump and process for manufacturing and installing the assembly.

### BACKGROUND

It is not uncommon to design a pump to be positioned on a surface of a container or supply vessel. FIGS. 1A and 1B illustrate a fuel pump 10 that is supported on a surface of a fuel tank 12 known in the prior art. In some applications, the fuel tank and pump are being transported in a truck or other mode of transportation. As such, an attachment end 14 that is secured to the fuel tank or supply vessel 12 is under a large amount of stress because of a movement arm that is cantilevered from the support by a body 16 that supports a motor 18 and overhang arrangement 20. The attachment end 14 is therefore susceptible to failure or fracture overtime.

In some applications, the supply vessel or fuel tank 12 is made from aluminum and the attachment end 14 includes a thread end that is received by the tank in a threaded connection seated in the vessel by a bung-welded flange 19. Since time and/or motion generating dynamic and static stresses either at the threaded connection, the welded flange 19 and/or pump end 14 may cause high levels of stress concentration and/or undesirable leaks in the system.

Further discussion on the operation, design, adaptation, uses, and construction of a pump is found in U.S. Design Pat. No.: D949,205 that is assigned to the applicant and assignee of the present disclosure. U.S. Design Pat. No.: D949,205 is incorporated herein by reference in its entirety for all purposes.

### SUMMARY

In one aspect, the present disclosure includes a support assembly and method for reducing a load on a pump. The support assembly includes an annular base support having a first diameter and a second diameter. A first set of threads is formed within the second diameter. The assembly also includes an annular adjustable support having a first diameter portion and a second diameter portion, a second set of threads formed within the second diameter portion. A threaded pairing connection is formed by adjustably coupling the first set of threads of the annular base support with the second set of threads of the annular adjustable support. A formation is created by the threaded pairing connection that extends from the first end of the adjustable support for coupling to a pump during use.

In another aspect, the present disclosure includes a supported pump system for reducing a load on a pump. The supported pump system includes a storage vessel for storing fluids during use, a pump arrangement having first and second ends that, when in use, is in fluid communication with the storage vessel. The first end of the pump arrangement is for coupling the pump arrangement to the storage vessel. The supported pump system also includes a support assembly having an annular base support with a first diameter and a second diameter, a first set of threads formed within the second diameter, an annular adjustable support having a first diameter portion and a second diameter portion, a second set of threads formed within the second diameter portion. A threaded pairing connection is formed by adjustably coupling the first set of threads of the annular base support with the second set of threads of the annular adjustable support. The support assembly also includes a nest extending from a connecting portion of the annular adjustable support for coupling to a second end of a pump arrangement during use and a damping element positioned within and extending from a base portion of the annular base support.

In yet another aspect, the present disclosure includes a method of manufacturing a support assembly for reducing a load on a pump. The method includes the steps of providing an annular base support having a first diameter and a second diameter, forming a first set of threads within the second diameter of the annular base support, providing an annular adjustable support having a first diameter portion and a second diameter portion, and forming a second set of threads within the second diameter portion of the annular adjustable support such that the first set of threads of the annular base support is adjustably couplable with said second set of threads of said annular adjustable support to support a pump positioned over a storage vessel.

### DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIGS. 1A and 1B illustrate a pump assembly affixed to a fuel tank as known in the prior art;

FIG. 2 illustrates a supported pump system attached to a supply vessel in accordance with one example embodiment of the present disclosure;

FIGS. 3-4 illustrate a support assembly constructed in accordance with one example embodiment of the present disclosure;

FIG. 3A illustrates a sectional view of the support assembly along section lines 3A-3A in FIG. 3;

FIGS. 5-6 illustrate an adjustable support constructed in accordance with one example embodiment of the present disclosure;

FIGS. 7-8 illustrate a base support constructed in accordance with one example embodiment of the present disclosure;

FIG. 9 is an upper rear left perspective view of a supported pump system affixed to a supply vessel in accordance with one example embodiment of the present disclosure, ;

FIG. 10 is an upper rear right perspective view thereof;

FIG. 11 is a lower front right perspective view thereof;

FIG. 12 is a lower front left perspective view thereof;

FIG. 13 is a rear elevation view thereof;

FIG. 14 is a front elevation view thereof;

FIG. 15 a right-side view thereof;

FIG. 16 is a left-side view thereof;

FIG. 17 is a top plan view thereof;

FIG. 18 is a bottom plan view thereof; and

FIG. 19 is an exploded view thereof.

FIG. 20 is an upper rear left perspective view of a supported pump system and support assembly in accordance with another example embodiment of the present disclosure;

FIG. 21 is an upper rear right perspective view thereof;

FIG. 22 is a lower front right perspective view thereof;

FIG. 23 is a lower front left perspective view thereof;

FIG. 24 is a rear elevation view thereof;

FIG. 25 is a front elevation view thereof;

FIG. 26 a right-side view thereof;

FIG. 27 is a left-side view thereof;

FIG. 28 is a top plan view thereof;

FIG. 29 is a bottom plan view thereof; and

FIG. 30 is an exploded view thereof.

FIG. 31 is a front perspective view of a supported pump system and support assembly in accordance with another example embodiment of the present disclosure;

FIG. 32 is a rear perspective view thereof;

FIG. 33 is rear elevation view thereof;

FIG. 34 front elevation view thereof;

FIG. 35 is a side view thereof;

FIG. 36 is a sectional view thereof at section lines 36-36 in FIG. 34; and

FIG. 37 is an exploded view thereof.

FIG. 38 is a front perspective view of a supported pump system and pump assembly in accordance with another example embodiment of the present disclosure;

FIG. 39 is a rear perspective view thereof;

FIG. 40 is rear elevation view thereof;

FIG. 41 front elevation view thereof;

FIG. 42 is a side view thereof; and

FIG. 43 is a sectional view thereof at section lines 43-43 of FIG. 41.

FIG. 44 is a rear perspective view of a supported pump system and pump assembly in accordance with another example embodiment of the present disclosure;

FIG. 45 is a front perspective view thereof;

FIG. 46 is front elevation view thereof;

FIG. 47 rear elevation view thereof;

FIG. 48 is a side view thereof; and

FIG. 49 is a sectional view thereof at section lines 49-49 of FIG. 47.

FIG. 50 is a perspective view of a supported pump system and pump assembly in accordance with another example embodiment of the present disclosure;

FIG. 51 is an elevation view thereof;

FIG. 52 is a side view thereof; and

FIG. 53 is a sectional view thereof at section lines 53-53 of FIG. 51.

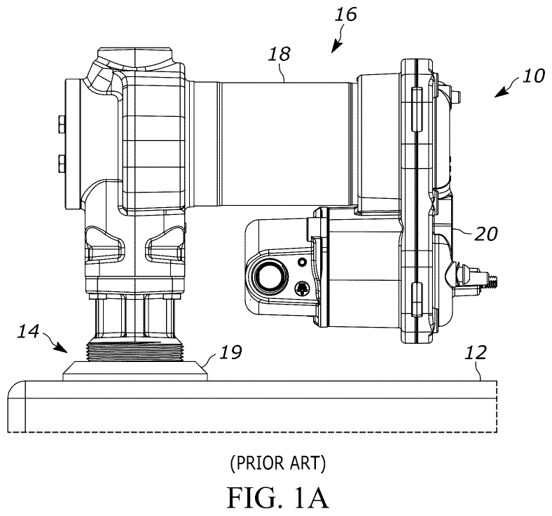

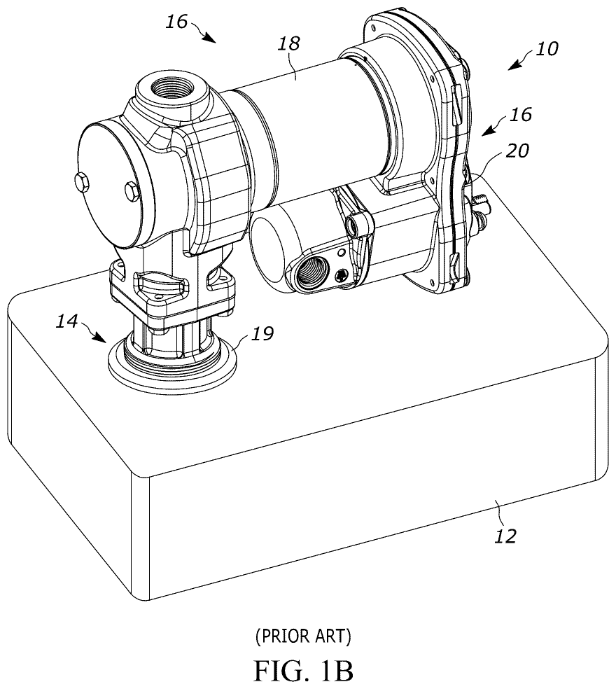

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure. Further, the utility and purpose of many structures are shown in the figures are described throughout the specification. However, it should be appreciated that some of the structures shown in the figures have been selected or invented for aesthetic appearance and ornamental design independent of its utilitarian operation or lack thereof.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures wherein like numbered features shown therein refer to like elements throughout unless otherwise noted. The present disclosure generally relates to a support assembly for a pump arrangement and method and more particular an assembly and method of supporting a pump and process for manufacturing and installing the assembly.

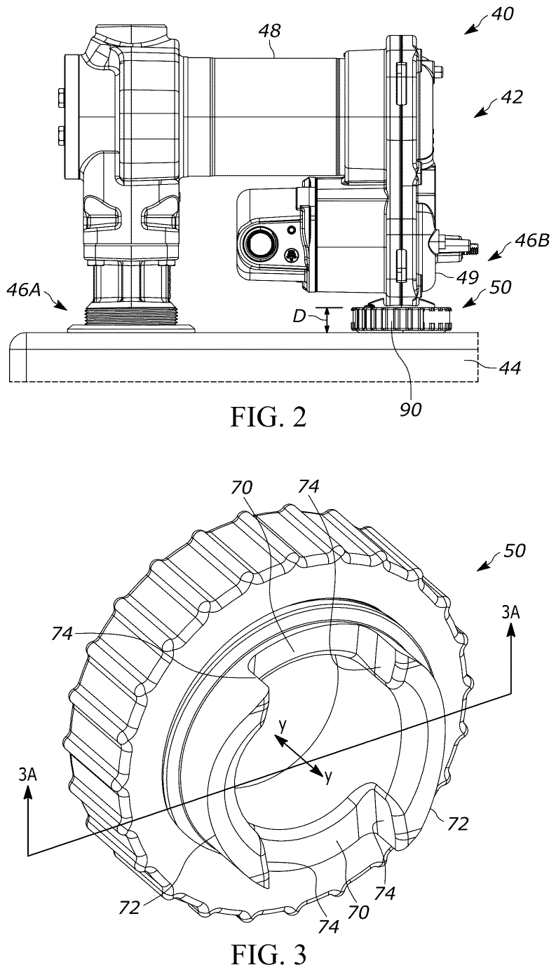

Illustrated in FIG. 2 is a supported pump system 42 attached to a supply vessel 44 in accordance with one example embodiment of the present disclosure. The supported pump system 42 in one example embodiment comprises a pump arrangement 40 and support assembly 50. The supply vessel 44, such as a storage tank, fluid tank, and/or fuel tank, is in fluid communication with the pump arrangement 40 and provides the fluids that are conveyed by the pump arrangement 40. An example of further discussion on the operation, design, adaptation, uses, and construction of a pump arrangement 40 is found in U.S. Pat. No. 10,590,939 that is assigned to the applicant and assignee of the present disclosure. U.S. Pat. No. 10,590,939 is incorporated herein by reference in its entirety for all purposes.

The support assembly 50 is used with the pump arrangement 40. The pump arrangement 40 includes a first end 46A and a second end 46B that is cantilevered about the first end. The first end 46A in one example embodiment includes a threaded pump member that is sealing engaged with a seal flange attached to the supply vessel or tank 44. In another example embodiment, the supply vessel 44 is a fuel tank and the seal flange is welded to the tank. In yet another example embodiment, the supply vessel is made from metal or alloy such as steel or aluminum or a polymeric material such as a plastic, or any combination thereof. Advantageously, the support assembly 50 is compatible with a variety of tanks in a variety of sizes. In one example embodiment of the present disclosure, the support assembly 50 has an extension height ranging from 0.5-0.8 inches. One of ordinary skill in the art, after having the benefit of reviewing the specification and drawings of the present disclosure, would understand that the support assembly 50 can be dimensioned and configured to form a variety of minimum and maximum heights.

The support assembly 50 is positioned under the second end 46B of the pump to eliminate the void “D” as shown in FIG. 2 and the stress concentration at the first end based on the cantilevered configuration of the pump arrangement 40. Stated another way, the support assembly 50 eliminates or reduces the possibility of damage to a supply vessel 44 from the cantilever load of a pump arrangement 40 installed on the supply vessel 44, the supply vessel 44 often being a thin-walled aluminum fuel tank. By providing an additional support to the pump arrangement 40 installed onto the supply vessel 44, the loading condition becomes balanced and optimal. The stresses at the first end 46A and the bung weld is dramatically reduced, and fatigue life of fuel tank 44 as a whole is also greatly improved.

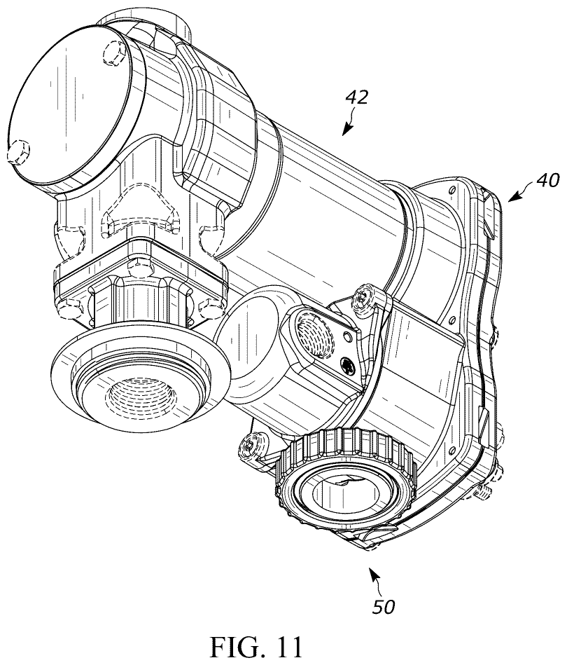

Advantageously, the support assembly 50 can be positioned under the second end 46B of pump 40 in multiple different locations to create a supported pump system 42. In one example embodiment of the present disclosure, the support assembly 50 is positioned under a motor housing of a pump 40 to form a supported pump system 42, as illustrated in FIG. 11. In this example embodiment, the support assembly 50 can also be positioned under a switch plate of the pump 40 to form a supported pump system 42, as shown in FIG. 2.

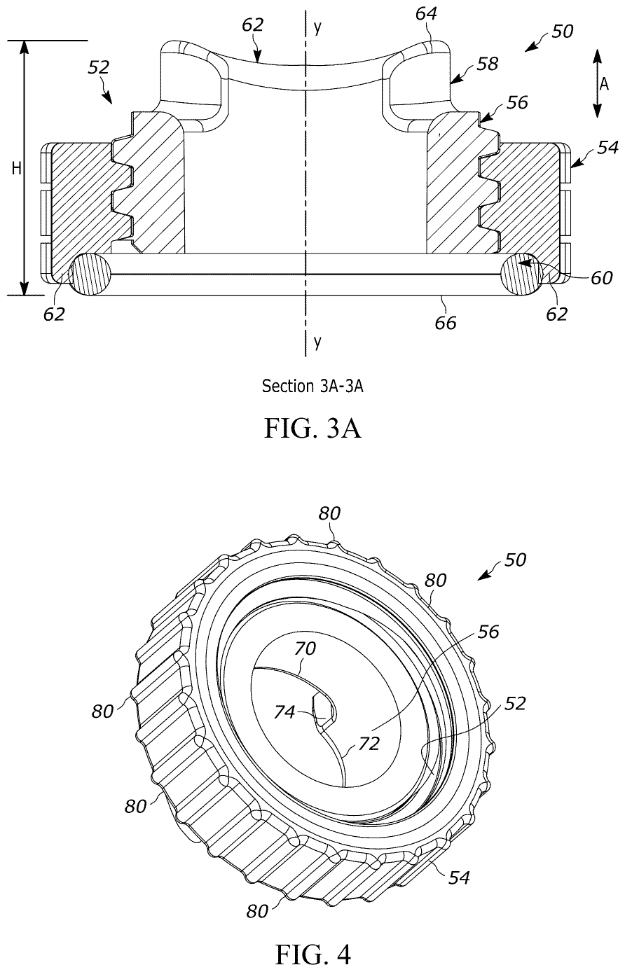

FIGS. 3-4 illustrate a support assembly 50 constructed in accordance with one example embodiment of the present disclosure. FIG. 3A illustrates a sectional view of the support assembly 50 along section lines 3A-3A in FIG. 3. The support assembly 50 in one example embodiment is load-bearing bracket with height adjustable threading pair supporting the pump arrangement 40 at the second end 46B of cantilever beam formed by the body 48 of the pump. The support assembly 50 reduces the stress concentration at the first end 46A of the pump by removably coupling the support assembly 50 in an adjustably fixed connection between the pump and supply vessel 44.

The support assembly 50 further mitigates any resonance through a vibration absorption damping element 60 at the base of the support system 50 that also provides the function of keeping the assembly under a load.

In one example embodiment of the present disclosure, the support assembly 50 is made of a UV-resistant and waterproof elastomeric material, such as rubber or silicone. In another example embodiment, the support assembly 50 is made from a polymeric material such as plastic.

In one example embodiment, the support assembly 50 comprises a threading pair 52 formed from a base support 54, and adjustable support 56. The assembly 50 further comprises a support collar that extends from the adjustable support 56. The assembly also comprises in one example embodiment a damping element 60 nested in a channel 62 of the base support 54, the damping element extending from the channel beyond the base element. In another example embodiment, the components forming the support assembly 50, namely the base support 54, adjustable support 56, and frictional base 60 are annular in shape.

As illustrated in the cross-sectional view of FIG. 3A, the base support 54 and adjustable support 56 provide a threaded pair 52 by an internal/external thread combination for altering the location of a first end 64 of the assembly 50 relative to the base support. Stated another way, the adjustable support 56 when rotated in a first direction about a central axis y-y results in an increase in overall height “H” of the assembly 50. When the adjustable support 56 is rotated in a second direction about a central axis y-y, this results in a decrease in overall height “H” of the assembly 50, as illustrated in FIG. 3A. This adjustment of the threaded pair 52 described by the relative rotation of the adjustable support 56 to the base support 54 selectively allows the support assembly 50 to adjust to the distance D in FIG. 2, providing support to the second end 46B of the pump arrangement 40 to form a supported pump system 42.

The support assembly 50 during installation is positioned under the switch plate 49 and adjusted via threaded pair 52 so that the cantilever stress concentration at the first end 46A is minimized or substantially zero.

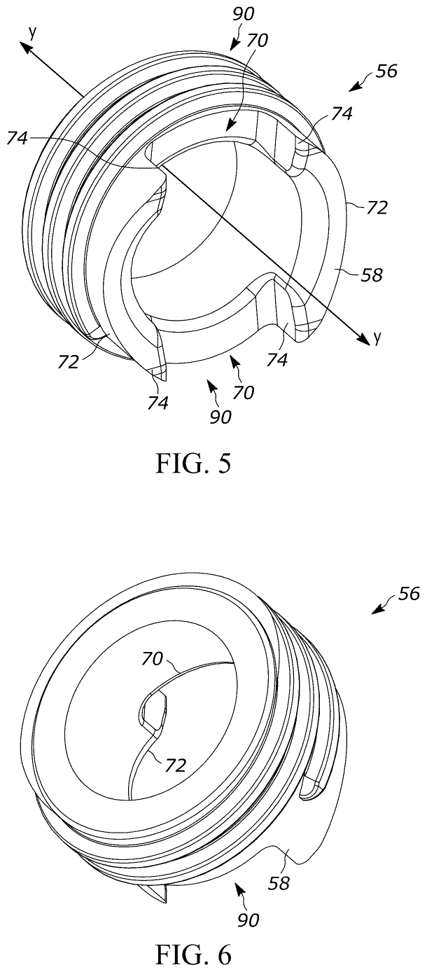

In the illustrated example embodiment of FIGS. 5-6 the adjustable support 56 includes a nest 70 substantially one hundred and eighty degrees (180) apart spaced by a rise 72 substantially one hundred and eighty degrees (180) apart. The nest 70 and rise 72 together create a formation 90 which allows for a u-shaped connection with the pump arrangement 40 at the switch plate 49.

In one example embodiment for installation, the support assembly 50 is positioned under the switch plate 49. The support assembly 50 is adjusted prior to insertion under the switch plate 49 such that walls 74 extending from the nest 70 to form the rise 72 would engage corresponding components on the pump 40 if translated in any direction transverse to the direction of insertion. Once the support assembly 50 is under the switch plate 49, the assembly 50 is rotated until one or more walls engage the pump arrangement 40. The support base 54 is then rotated in a first direction such that the threaded pairs 52 create an increase in the height H of the assembly 50 to substantially match the distance D to reduce the stress concentration at the first end 46A to substantially zero. In one example embodiment, the support base 54 includes a tread 80 about its perimeter, allowing the assembly 50 to be rotated and fixed into place under the pump 40 without the need of any tools.

Assisting in the adjustment and fixed coupling of the support assembly 50 to the pump arrangement 40 is further facilitated by the damping element 60 that yields when the support is reaching a sufficient level between the assembly 50 and the arrangement 40. That is, the damping element 60 compresses, keeping the support assembly 50 under load. In one example embodiment, the damping element 60 is an o-ring. In another example embodiment the damping element 60 is made from rubber, neoprene, and/or a polymeric material. The damping element 60 further advantageously provides a frictional surface to prevent slippage of the support assembly 50 when coupled to the pump arrangement 40. The damping element 60 further reduces vibrations on the supported pump system because it is formed from a flexible material.

It should be appreciated by one of ordinary skill in the art having the advantage of reviewing the present disclosure and accompanying drawings that a u-shaped formation 90 formed by nest 70 and rise 72 could be other geometrical configurations to match the construction of the pump arrangement 40. That is, the formation 90 is molded, machined, adapted or any combination thereof to be configured to fit the switch plate 49 to operate as described.

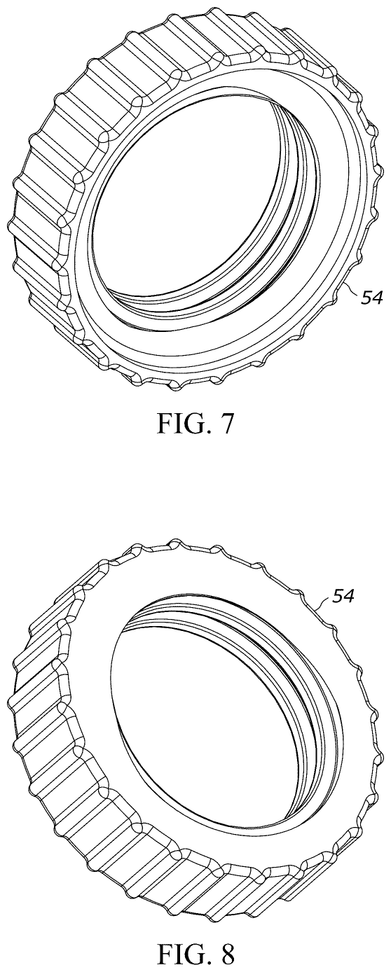

FIGS. 7-8 illustrate a base support 54 constructed in accordance with one example embodiment of the present disclosure. As also shown in FIG. 4, in one example embodiment, the support base includes a tread 80 about its perimeter, allowing the assembly 50 to be rotated and fixed into place under the pump 40 without the need of any tools.

It should be appreciated by one of ordinary skill in the art having the advantage of reviewing the present disclosure and accompanying drawings that the support assembly 50 can be used to support pumps 40 that have multiple overhangs or cantilevered members. For example, a pump 40 can be t-shaped, extending from the supply vessel 44 in which a support 50 can be utilized under both arms of the pump to mitigate stress and vibration. In yet another example embodiment, multiple adjustable supports 56 are provided with varying lengths to provide a wide range of translational support of the overall height H of the support system 50. In another example embodiment it is possible to stack two or more support systems 50 to meet the height H requirements. In one example embodiment, the height adjustment H from the thread pair 52 will range from approximately one-half of one inch (½″) to multiple inches.

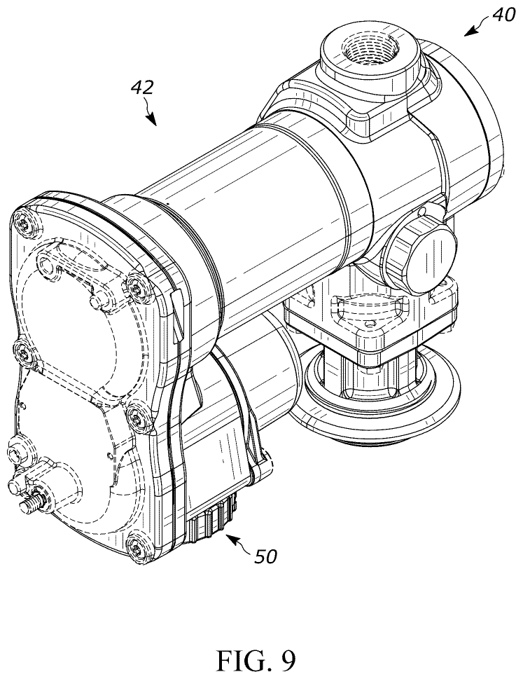

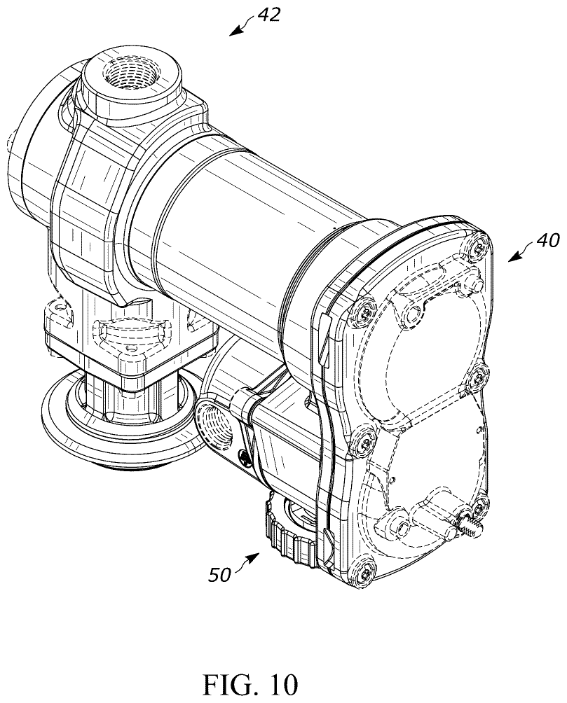

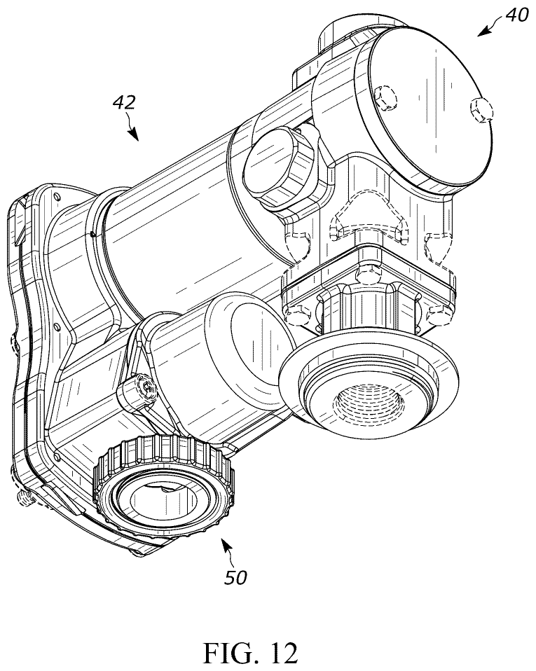

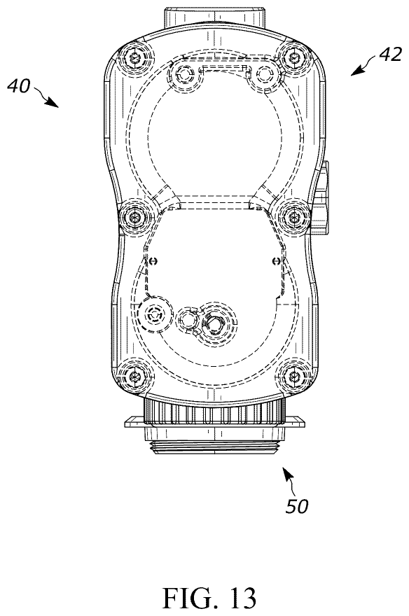

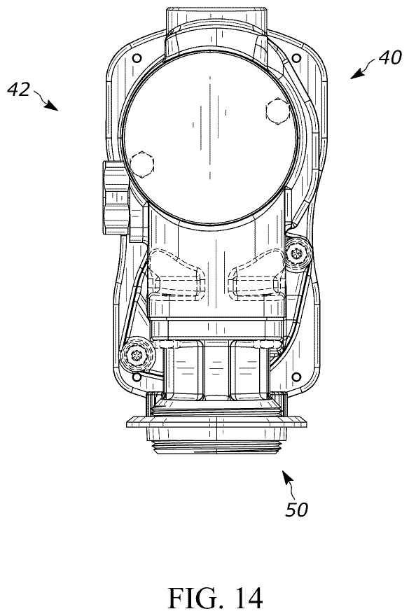

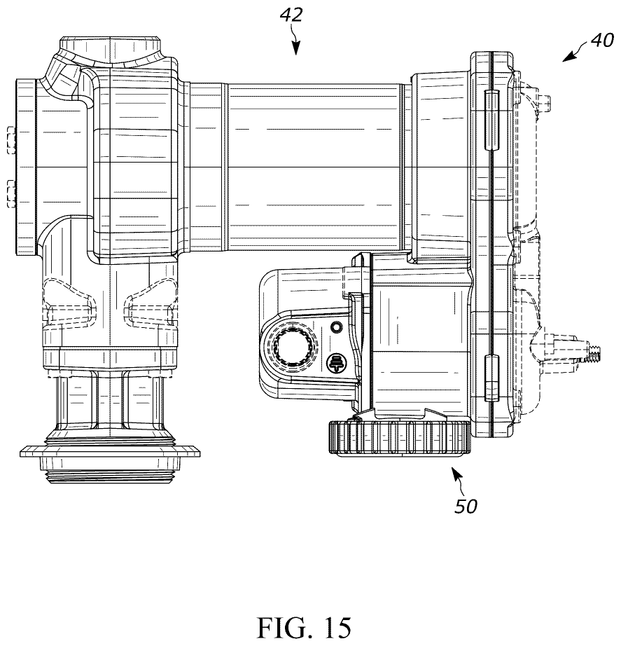

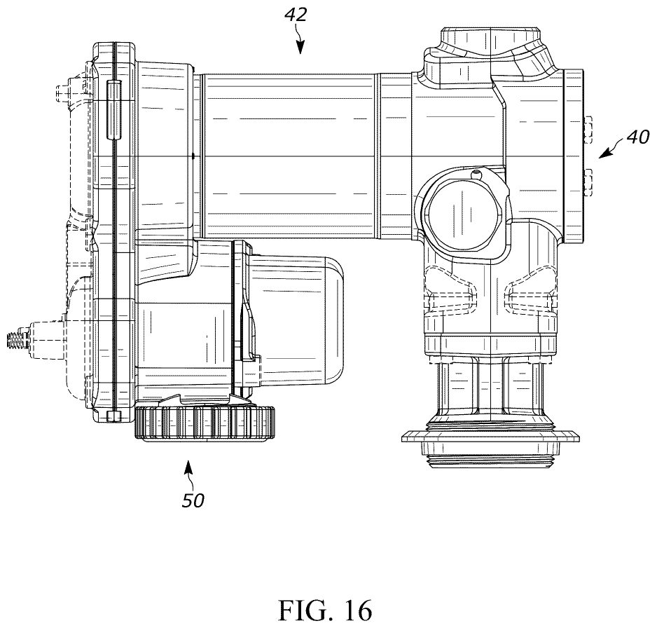

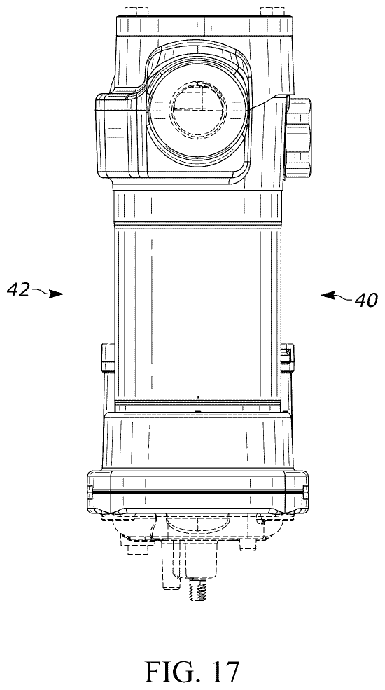

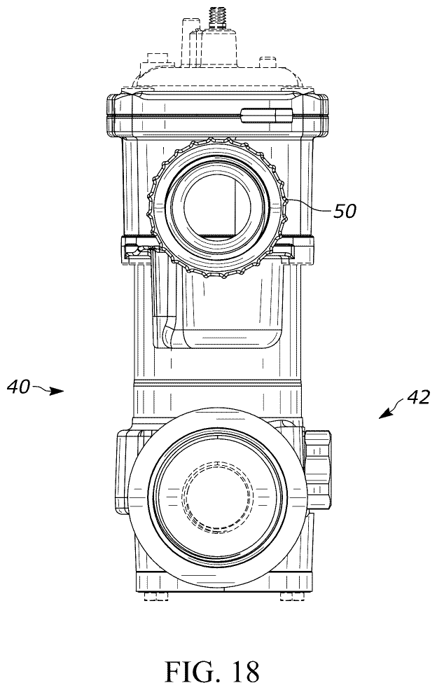

FIG. 9 illustrates a supported pump system 42 affixed to a supply vessel in accordance with one example embodiment of the present disclosure. FIGS. 10-18 illustrates several views of a supported pump system 42 in accordance with one example embodiment of the present disclosure.

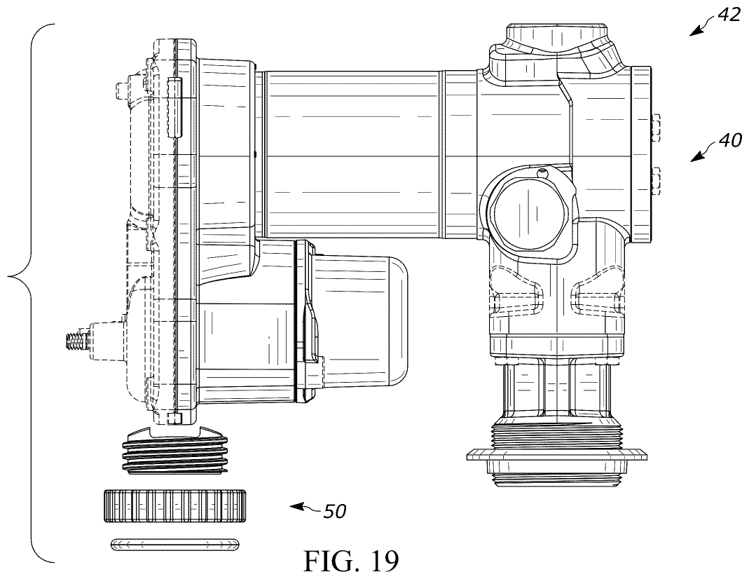

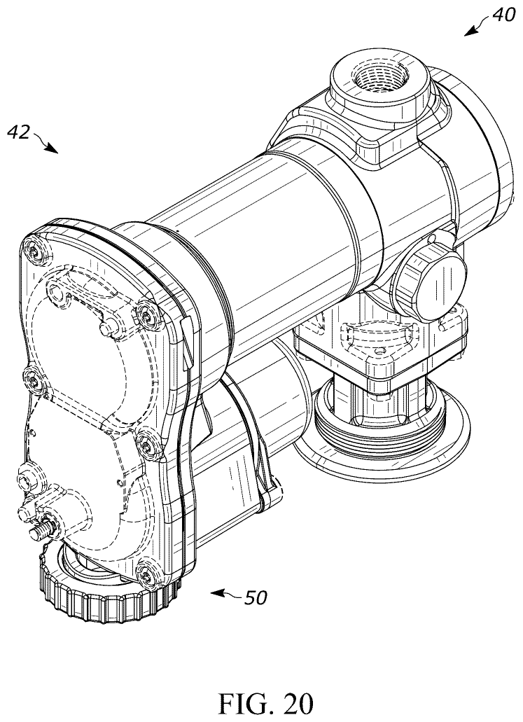

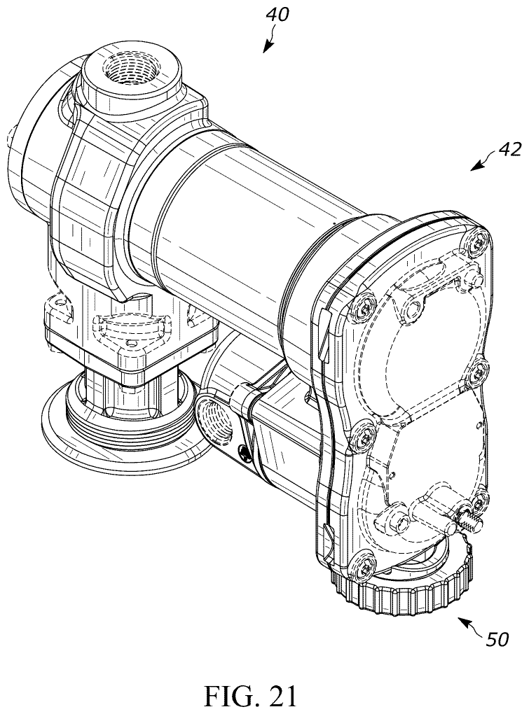

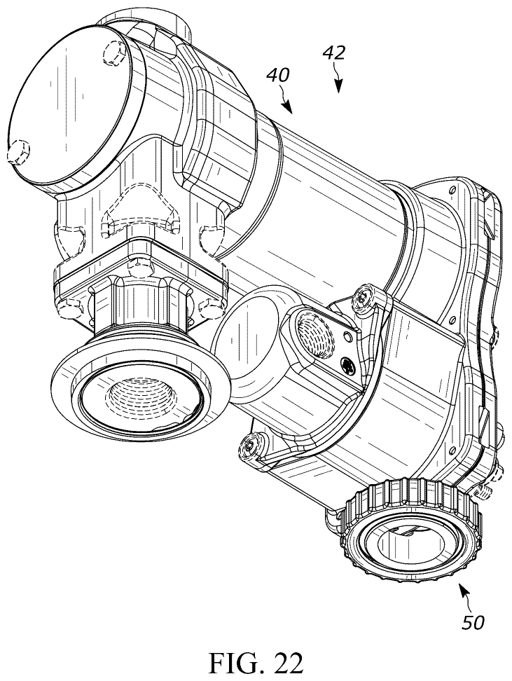

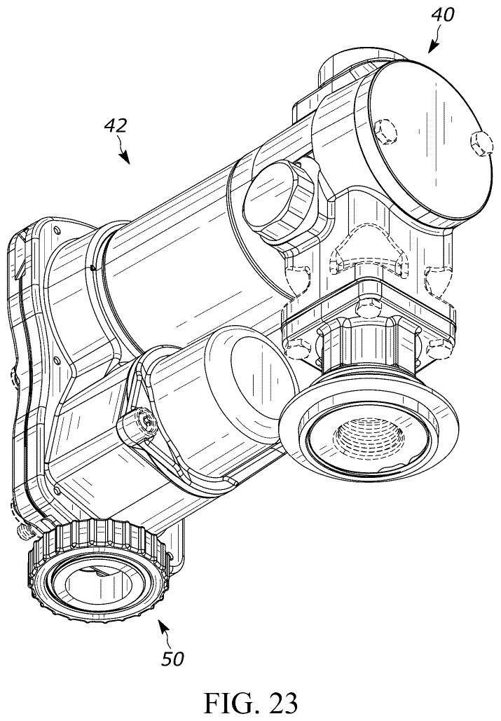

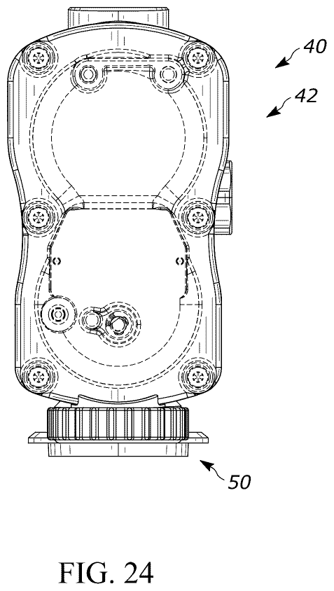

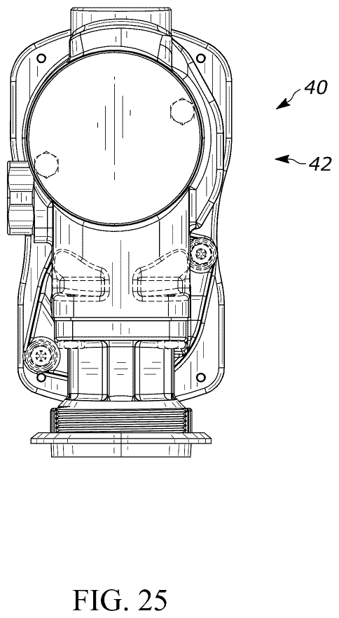

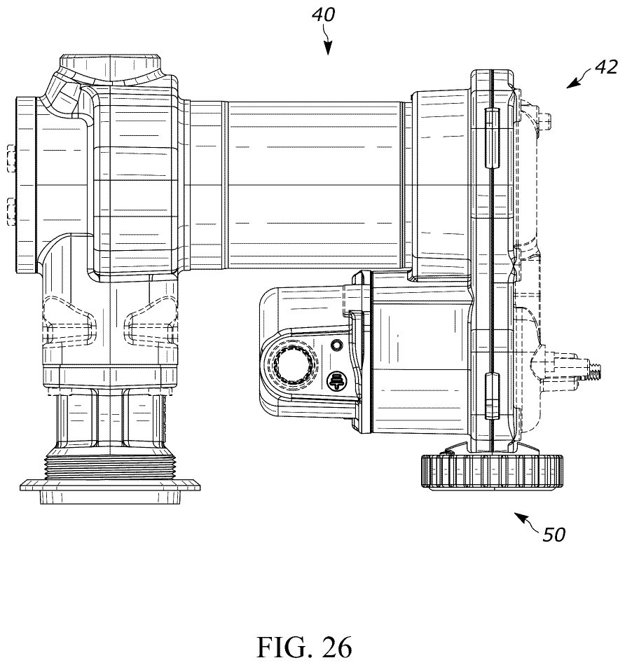

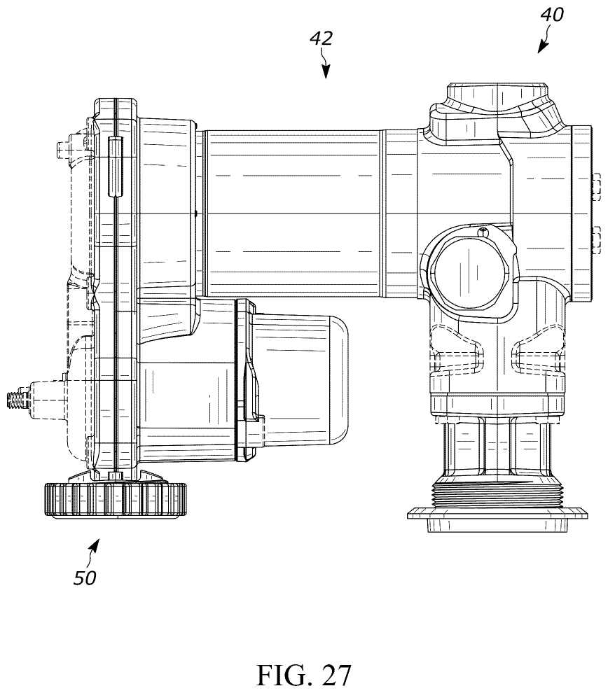

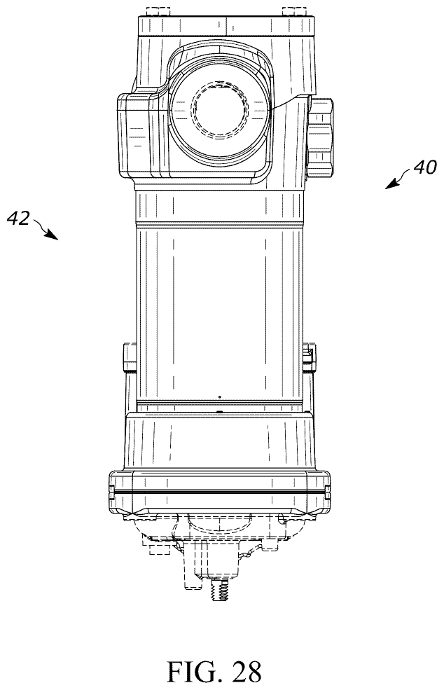

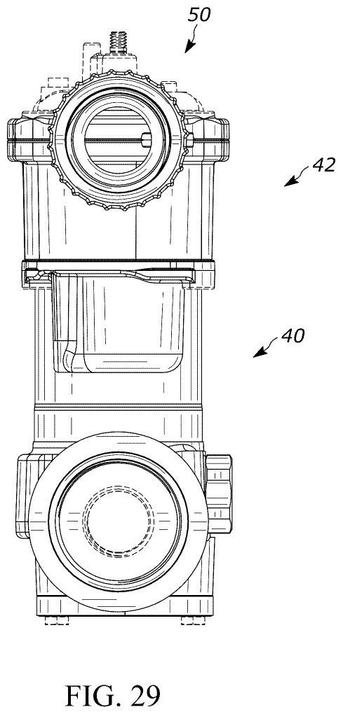

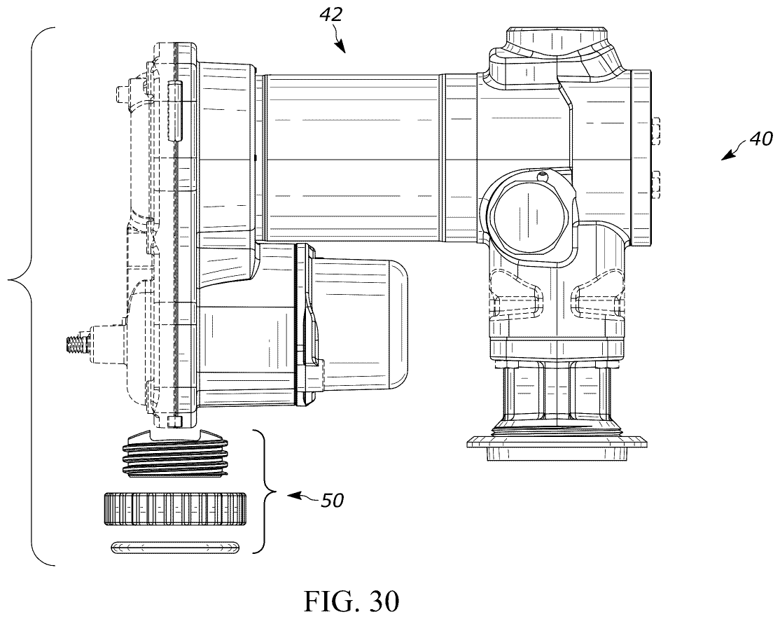

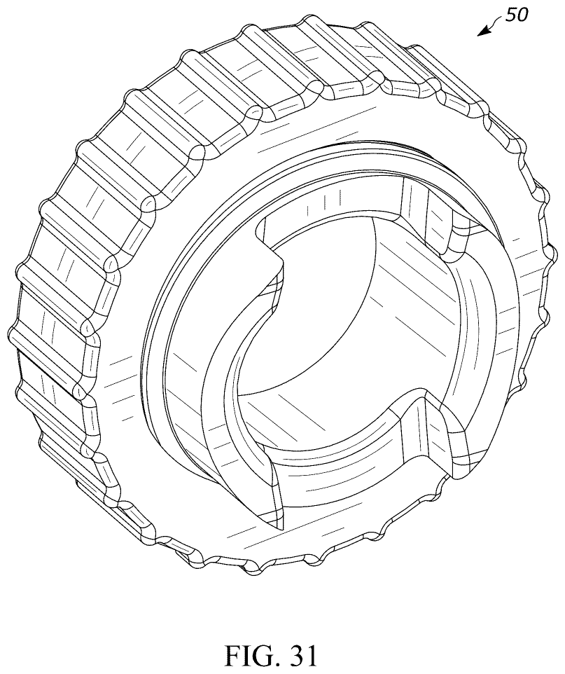

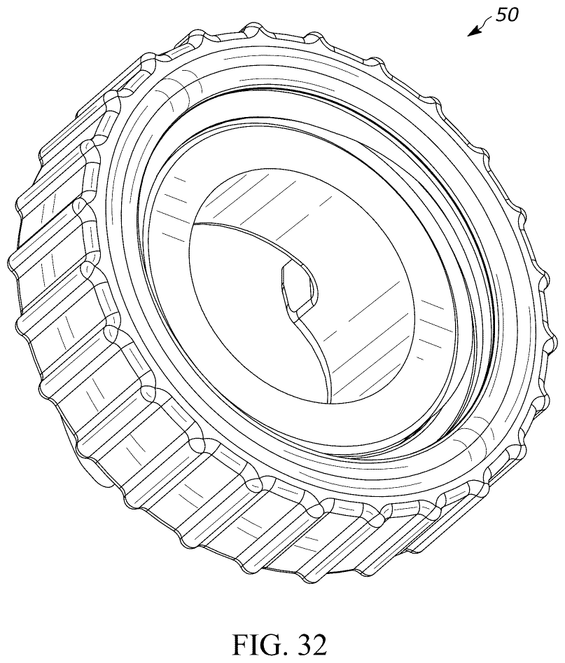

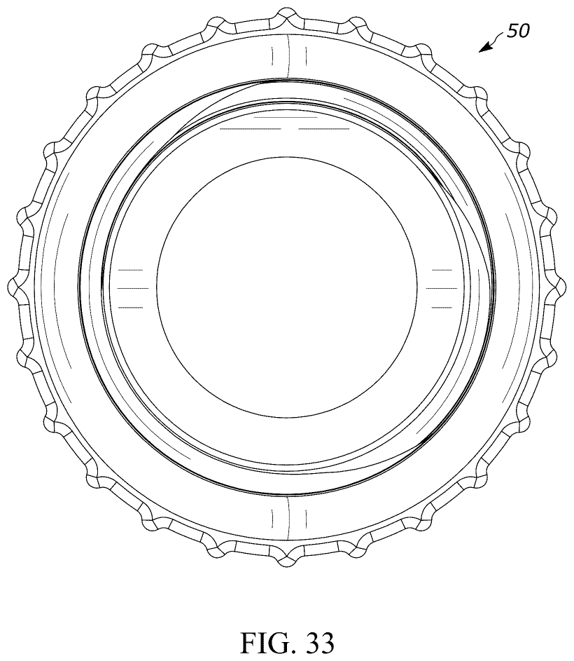

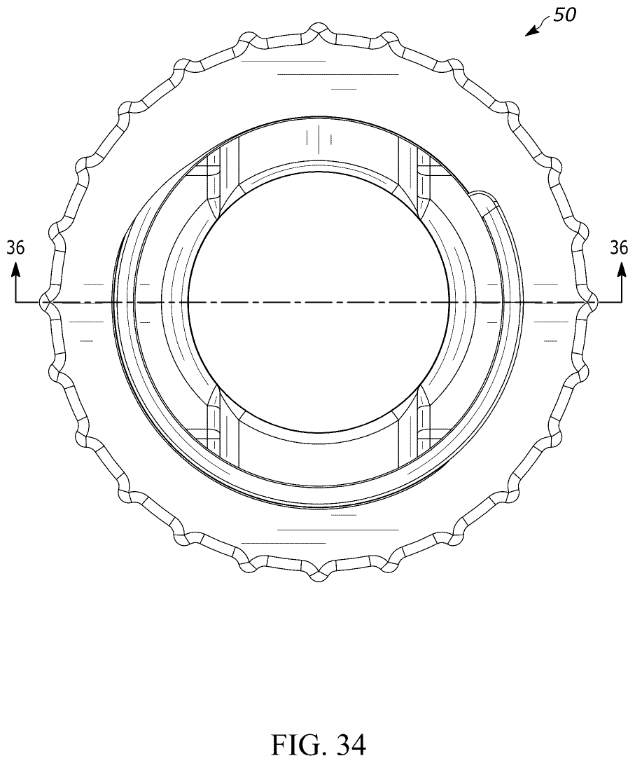

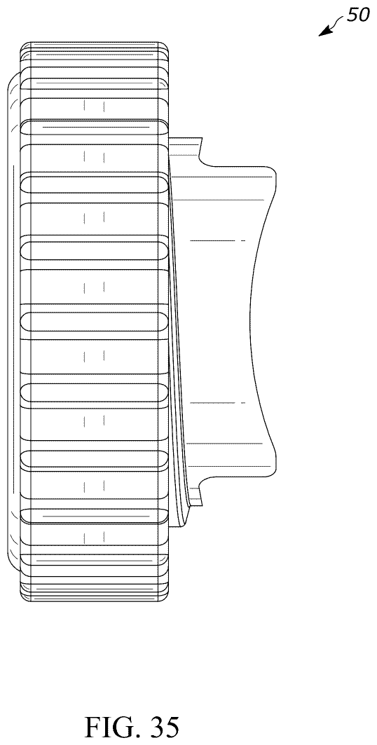

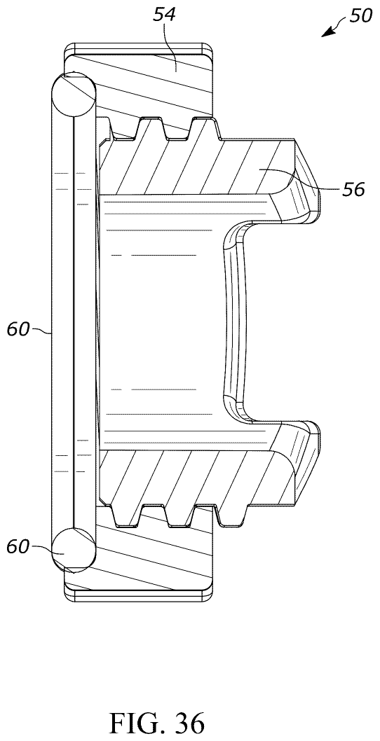

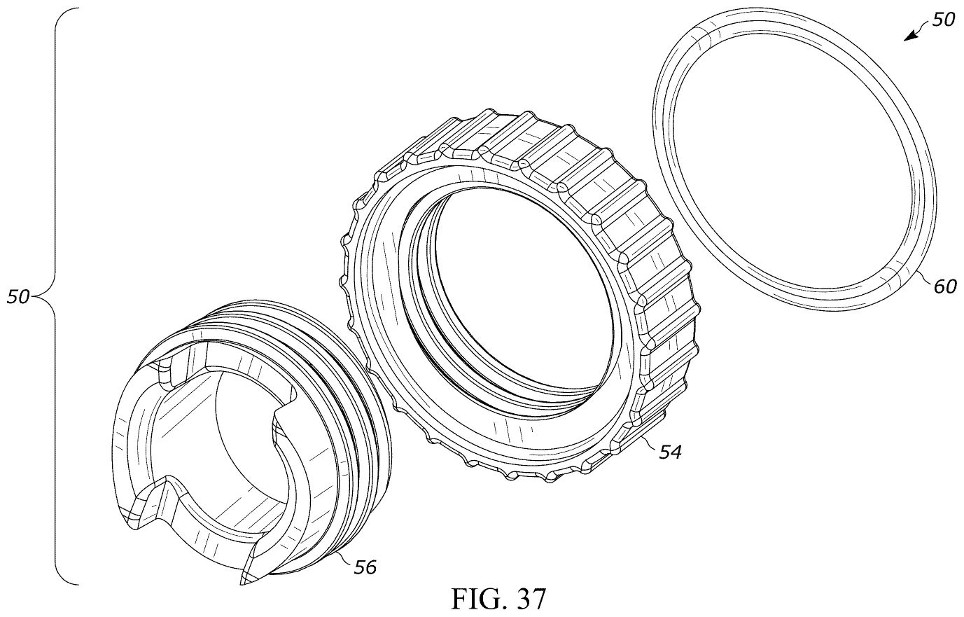

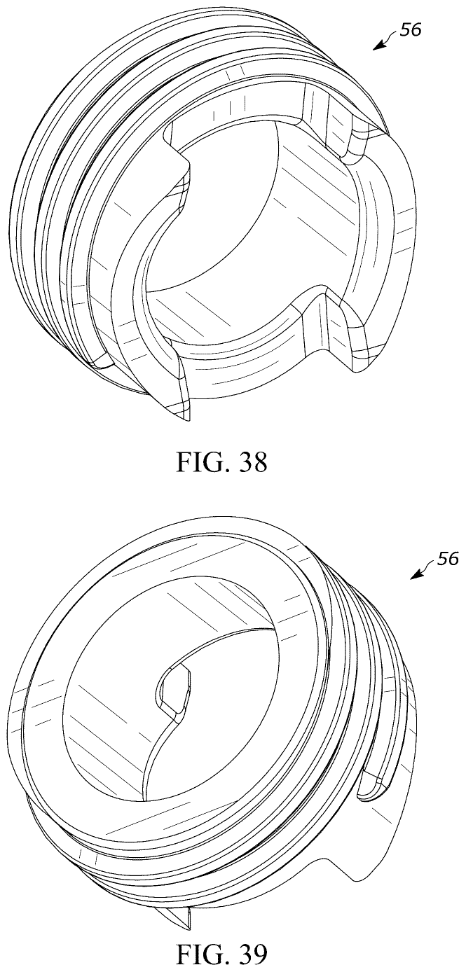

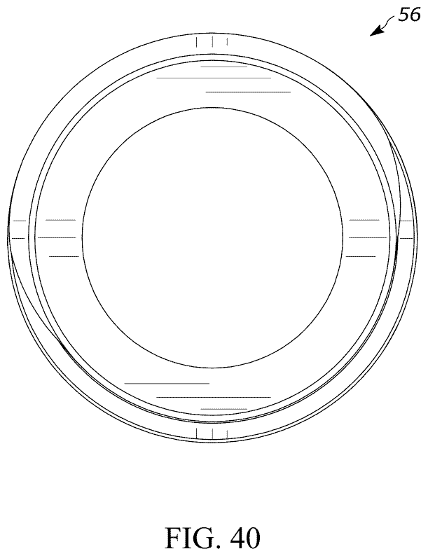

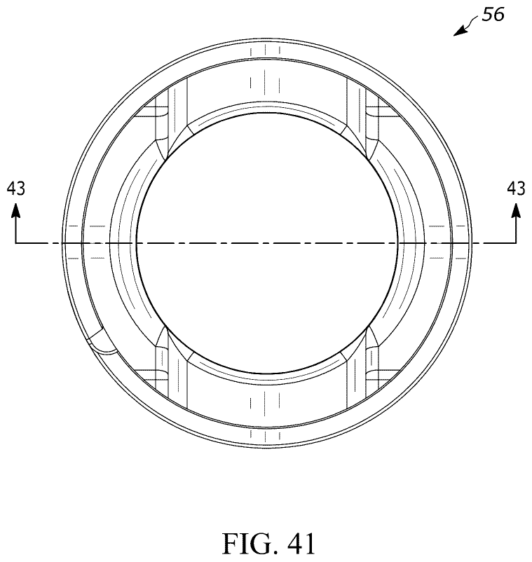

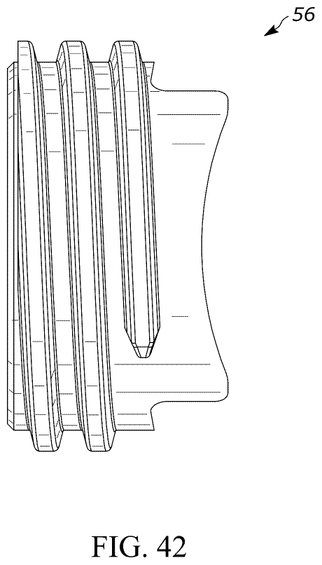

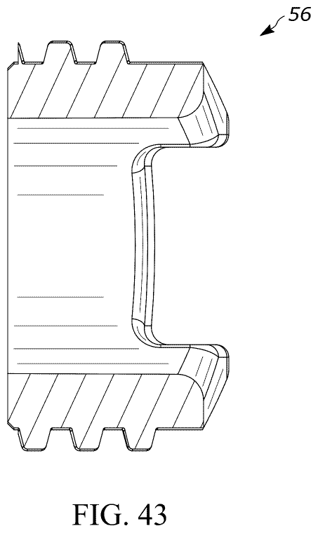

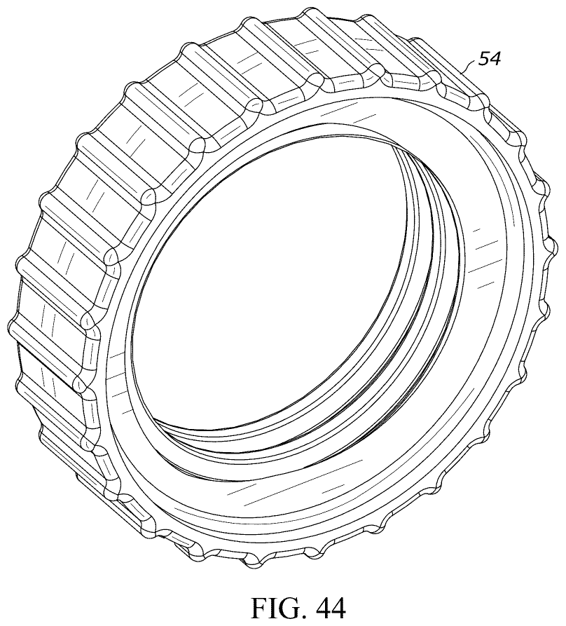

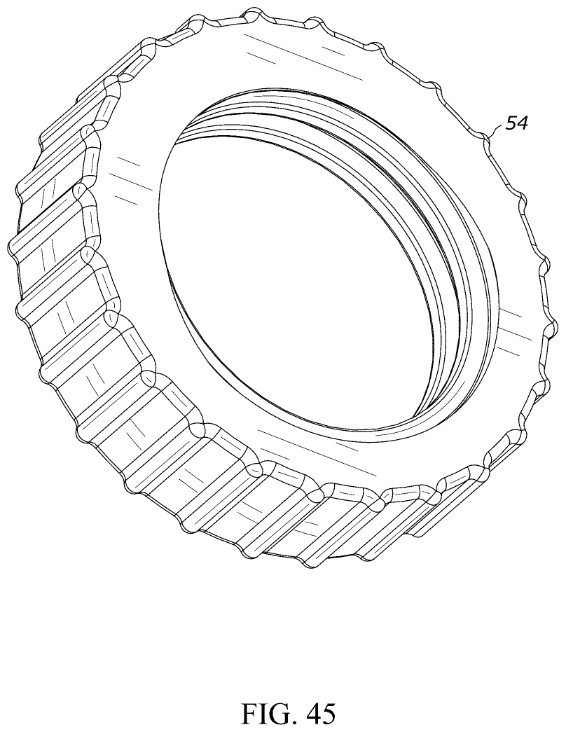

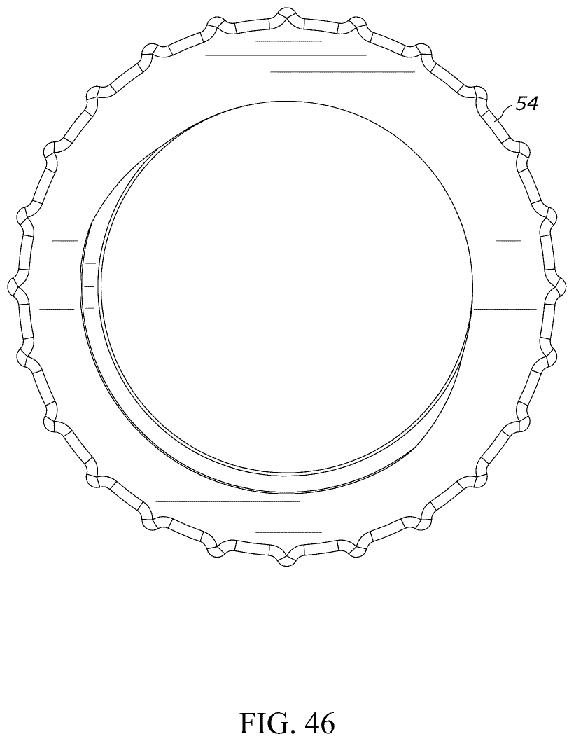

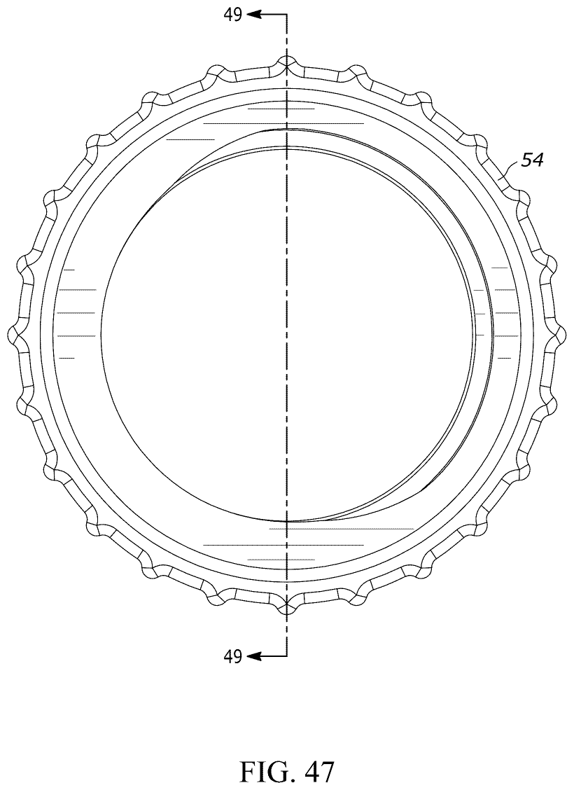

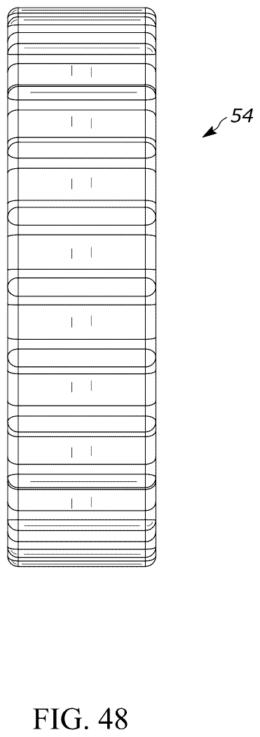

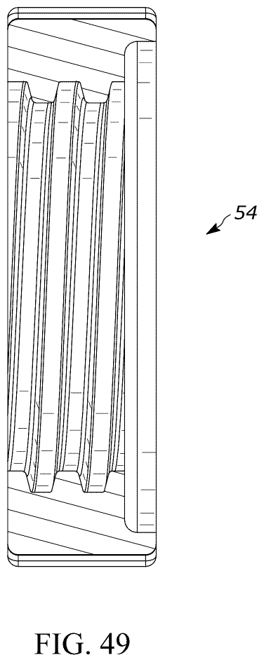

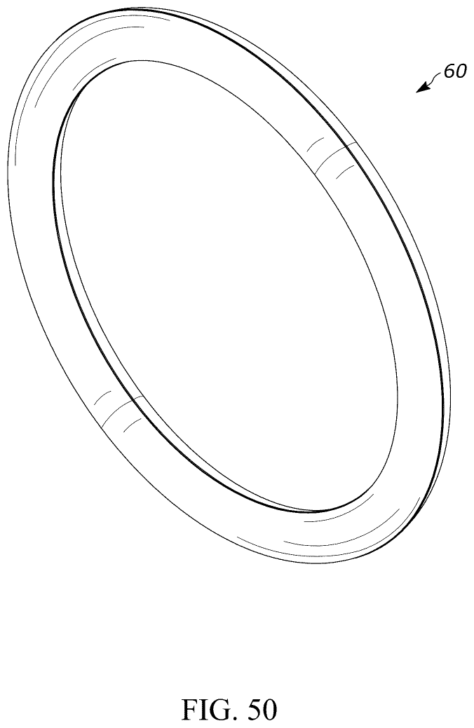

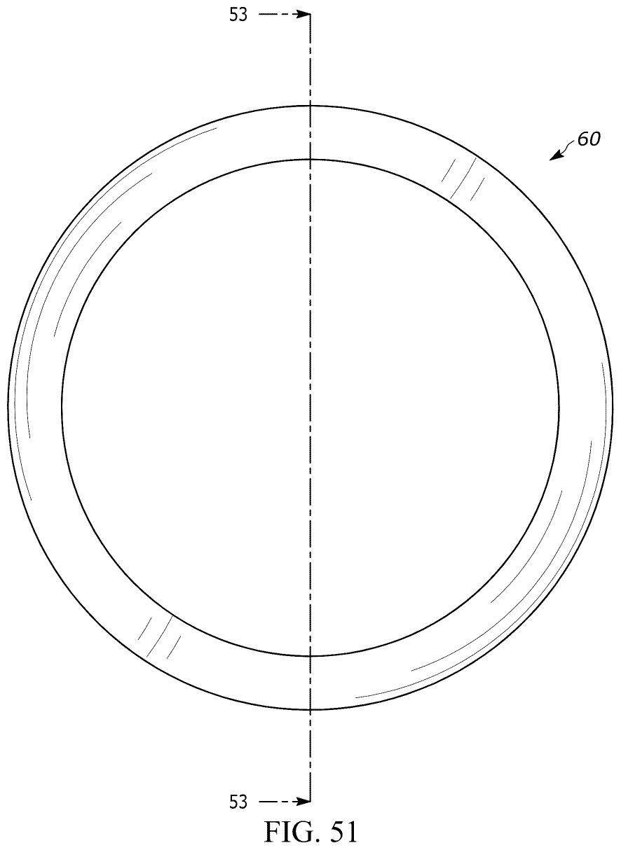

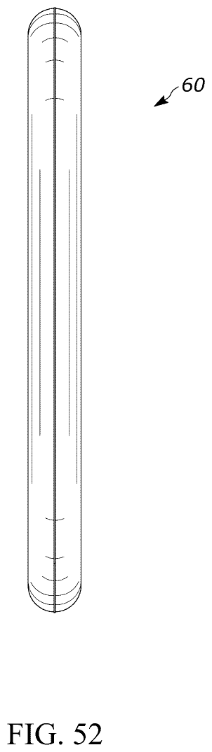

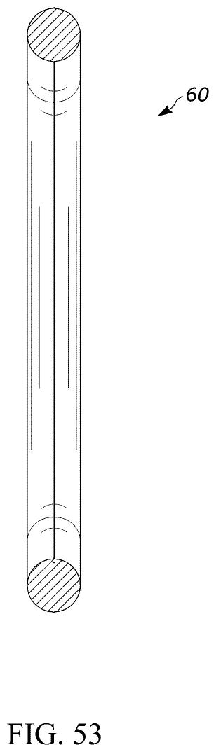

FIG. 19 illustrates a supported pump system 42 affixed to a supply vessel in accordance with another example embodiment of the present disclosure. FIGS. 20-53 illustrate several views of a supported pump system 42 in accordance with one example embodiment of the present disclosure.

It will be understood that the above description of the present disclosure is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Those of ordinary skill in the art will conceive of other alternate embodiments of the invention upon reviewing this disclosure. Thus, the invention is not to be limited to the above description but is to be determined in scope by the claims which follow.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way, but may also be configured in ways that are not listed. The terms “integral” or “integrated” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E1, E2, . . . En and that each embodiment E may have multiple parts A1, B1, C1 . . . Zn that (without further description) could be combined with other embodiments En, embodiment parts e.g. A1, C1, or lack of parts originally associated with one or all embodiments En, or any combination of parts and/or embodiments thereof. It should further be appreciated that an embodiment En may include only one part e.g. A1 or a lesser number of parts e.g. B1, C1 of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A support assembly for reducing a load on a pump or a supply vessel when in use, the support assembly comprising:
an annular base support having a first diameter and a second diameter, a first set of threads formed within said second diameter;
an annular adjustable support having a first diameter portion and a second diameter portion, a second set of threads formed within said second diameter portion;
a threaded pairing connection formed by adjustably coupling said first set of threads of said annular base support with said second set of threads of said annular adjustable support, wherein said threaded pairing connection creates a formation extending from said annular adjustable support for coupling to the pump during use.

2. The support assembly of claim 1 further comprising a damping element positioned within and extending from said second diameter of said annular base support.

3. The support assembly of claim 1 wherein said formation comprises an annular extension from said annular adjustable support with a u-shaped channel.

4. The support assembly of claim 3 wherein said formation comprising an annular extension from said annular adjustable support further comprises substantially diametrically opposed first and second u-shaped channels.

5. The support assembly of claim 1 wherein said annular base support further comprises a tread about a perimeter of its first diameter.

6. The support assembly of claim 1 wherein said threaded pairing is adjustable upon turning said threaded pairing in a first direction or a second direction.

7. The support assembly of claim 6 wherein a height of said support assembly is increased upon adjusting said threaded pairing in said first direction.

8. The support assembly of claim 7 wherein said height of said support assembly is decreased upon adjusting said threaded pairing in said second direction.

9. The support assembly of claim 2 wherein said damping element comprises a frictional surface to prevent slippage of said support assembly.

10. A supported pump system for reducing a load on a pump or storage vessel during use, the supported pump system comprising:
a storage vessel for storing fluids during use;
a pump arrangement that, when in use, is in fluid communication with said storage vessel, said pump arrangement having a first end and a second end, said first end for coupling said pump arrangement to said storage vessel; and
a support assembly comprising:
an annular base support having a first diameter and a second diameter, a first set of threads formed within said second diameter;
an annular adjustable support having a first diameter portion and a second diameter portion, a second set of threads formed within said second diameter portion;
a threaded pairing connection formed by adjustably coupling said first set of threads of said annular base support with said second set of threads of said annular adjustable support;
a nest extending from a connecting portion of said annular adjustable support for coupling to a second end of a pump arrangement during use; and
a damping element positioned within and extending from a base portion of said annular base support.

11. The supported pump system of claim 10 wherein said damping element is made of an elastomeric material.

12. The supported pump system of claim 10 wherein said damping element includes a substantially circular cross-section.

13. The supported pump system of claim 10 wherein said nest comprises an annular extension from said annular adjustable support having a first u-shaped channel.

14. The supported pump system of claim 13 wherein said nest comprising an annular extension from said annular adjustable support further comprises a second u-shaped channel which is substantially diametrically opposed from said first u-shaped channel.

15. The supported pump system of claim 10 wherein said support assembly is removably couplable to said second end of said pump arrangement at a motor housing of said pump arrangement.

16. The supported pump system of claim 10 wherein said support assembly is removably couplable to said second end of said pump arrangement at a switch plate of said pump arrangement.

17. A method of manufacturing a support assembly for reducing a load on a pump or storage vessel during use, the method comprising the steps of:
providing an annular base support having a first diameter and a second diameter;
forming a first set of threads within said second diameter of said annular base support;
providing an annular adjustable support having a first diameter portion and a second diameter portion; and
forming a second set of threads within said second diameter portion of said annular adjustable support such that said first set of threads of said annular base support is adjustably couplable with said second set of threads of said annular adjustable support to support a pump positioned over a storage vessel during use.

18. The method of claim 17, further comprising the step of coupling said annular base support with said annular adjustable support at said first set of threads and said second set of threads.

19. The method of claim 18 further comprising the step of rotating said annular base support of said support assembly in a first direction such that the threaded pairs create an increase in the height of the support assembly.

20. The method of claim 18 further comprising the step of rotating said annular base support of said support assembly in a second direction such that the threaded pairs create a decrease in the height of the support assembly.
